(19) United States
(12) Patent Application Publication
(10) Pub. No.: US 2026/0150872 A1
(43) Pub. Date: Jun. 4, 2026

(54) LOW-CALORIE COMPOSITION FOR FLAVOR MODIFICATION

(71) Applicant: Firmenich SA, Satigny (CH)

(72) Inventors: Srinivasan SUBRAMANIAN, Plainsboro, NJ (US); Melissa BORS, Plainsboro, NJ (US); Imad FARHAT, Dubai (AE); Shiv Kumar JAYARAM, Dubai (AE)

(73) Assignee: Firmenich SA, Satigny (CH)

(21) Appl. No.: 19/118,995

(22) PCT Filed: Oct. 25, 2023
(86) PCT No.: PCT/EP2023/079817

§ 371 Date: Apr. 7, 2025

Related U.S. Application Data
(60) Provisional application No. 63/421,426, filed on Nov. 1, 2022.

(30) Foreign Application Priority Data
Nov. 8, 2022 (EP) 22206225.9

(51) Int. Cl. A23L 2/60; A23L 27/30

(52) U.S. Cl. CPC A23L 27/36; A23L 2/02; A23L 2/56; A23L 2/60; A23L 27/84; A23L 27/86; A23L 27/88

(57) ABSTRACT

The present disclosure generally relates to mogroside compositions useful for improving the flavor of certain fruit juice compositions that have certain undesirable flavors, such as excessive astringency, bitterness, or sourness, or insufficient sweetness or mouthfeel. In some embodiments, the mogroside composition is monk fruit juice or monk fruit juice concentrate. In some embodiments, the mogroside composition comprises mogroside V, and, optionally, one or more other naturally occurring mogrosides.

### TECHNICAL FIELD

The present disclosure generally relates to mogroside compositions useful for improving the flavor of certain fruit juice compositions that have certain undesirable flavors, such as excessive astringency, bitterness, or sourness, or insufficient sweetness or mouthfeel.

In some embodiments, the mogroside composition is monk fruit juice or monk fruit juice concentrate. In some embodiments, the mogroside composition comprises mogroside V, and, optionally, one or more other naturally occurring mogrosides.

### DESCRIPTION OF RELATED ART

Fruit juices and beverages containing fruit juices are commonly consumed throughout the world. In general, the most popular such juices are those that have higher concentrations of sugars and lower concentrations of compounds that contribute to bitterness, astringency, unpleasant mouthfeel, and the like. But the consumption of high-sugar beverages has increasingly come under scrutiny, as such beverages are high in calories and may contribute to various diseases.

Metabolic disorders and related conditions, such as obesity, diabetes, and cardiovascular disease, are major public health concerns throughout the world. And their prevalence is increasing at alarming rates in almost every developed country. Caloric sweeteners, such as those naturally found in fruit juices, are a key contributor to this trend. Thus, there is a desire to shift consumers towards juices or juice blends that are lower in natural sugars. In many cases, these lower-sugar alternatives also contain higher concentrations of certain polyphenols, which impart certain health benefits. Even so, consumers tend to perceive these juices as being less sweet, and, in some cases, as having an unpleasant astringency or mouthfeel.

One can obviously address this problem by adding sugars to these juices, such as sucrose of fructose. But this nullifies many of the health benefits achieved from using juices that are naturally lower in sugars. One could add certain artificial sweeteners instead, but this has the advantage of creating a product that is no longer natural. Thus, there is a continuing need to discover natural compositions that one can introduce to such lower-sugar juices to enhance their sweetness, mask their astringency, or improve their mouthfeel without increasing the caloric content to a significant degree.

### SUMMARY

The present disclosure relates to the discovery that certain mogroside compositions can be introduced to fruit juice blends to reduce or mask one or more undesirable flavors, such as enhancing a sweet taste, reducing a bitter taste, reducing astringency, or enhancing mouthfeel of the fruit juice blend.

In a first aspect, the disclosure provides uses of a mogroside composition to reduce one or more undesirable flavors or enhance a fruity flavor of a fruit juice composition. In certain related aspects, the disclosure provides methods of reducing one or more undesirable flavors of a fruit juice composition, the method comprising introducing a mogroside composition to the fruit juice composition. In some embodiments, the mogroside composition is monk fruit juice, either in concentrated or unconcentrated form. In some embodiments, the use or method comprises enhancing a sweet taste. In some embodiments, the use or method comprises reducing astringency. In some embodiments, the use or method comprises reducing a bitter taste. In some embodiments, the use or method comprises enhancing mouthfeel. In some embodiments, the use or method comprises enhancing a fruity flavor.

In a second aspect, the disclosure provides an improved fruit juice composition, comprising: (a) a fruit juice composition; and (b) a mogroside composition. In some embodiments, the mogroside composition is monk fruit juice, either in concentrated or unconcentrated form.

Further aspects, and embodiments thereof, are set forth below in the Detailed Description, the Drawings, the Abstract, and the Claims.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the “ppm” refers to a concentration of mg/kg, based on the total weight of the composition.

A “sweetener” refers to a compound or ingestibly acceptable salt thereof that elicits a detectable sweet taste in a subject, e.g., a compound that activates the T1R2 and T1R3 taste receptors in vivo or in vitro.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

Other terms are defined in other portions of this description, even though not included in this subsection.

Mogroside Compositions and their Use

In its various aspects, the present disclosure provides uses of a mogroside composition to reduce one or more unpleasant flavors of a fruit juice composition, as well as related methods of use.

In certain aspects, the disclosure provides uses of a mogroside composition to reduce one or more undesirable flavors or enhance a fruity flavor of a fruit juice composition. In certain related aspects, the disclosure provides methods of reducing one or more undesirable flavors of a fruit juice composition, the method comprising introducing a mogroside composition to the fruit juice composition.

The uses and methods can relate to the reduction of any undesirable flavor or combination of undesirable flavors or enhancement of a fruity flavor. In some embodiments, the use or method comprises enhancing a sweet taste, for example, in fruit juice blends that have lower than usual amounts of natural sugars. In some embodiments, the use or method comprises reducing astringency, for example, in fruit juice blends that have a higher than usual concentration of astringent terpene compounds. In some embodiments, the use or method comprises reducing a bitter taste, for example, in fruit juices that have a higher than usual concentration of bitter compounds. In some embodiments, the use or method comprises enhancing mouthfeel, for example, in fruit juice blends that have a chalky mouthfeel. In some embodiments, the use or method comprises reducing a sour taste, for example, in fruit juice blends that have a higher than usual sour taste, for example, due to a higher concentration of organic acids. In some embodiments, the use or method comprises enhancing a fruity flavor, for example providing the fruit juice blend with a flavor (for example, a combination of taste and aroma) that is perceived by humans to be more characteristic of the fruit itself.

The mogroside composition can be any suitable composition comprising one or more mogrosides. As used herein, the term “mogroside” refers to a class of glycosides of certain cucurbitane derivatives, and includes such compounds as mogroside III, mogroside IV, mogroside V, siamenoside I, isomogroside V, mogroside IV_{E}, isomogroside IV, mogroside III_{E}, 11-oxo-mogroside V, or the 1,6-α isomer of siamenoside I, and the like. In some embodiments, the mogroside composition is monk fruit juice or monk fruit juice concentrate. Note that “monk fruit” refers to the fruit of the Siraitia grosvenorii plant, which is also known as luohan guo. The mogroside composition comprises one or more mogroside compounds. The mogroside compounds can make up any suitable proportion of the compounds present in the mogtoside composition. For example, in some embodiments, the mogroside compounds make up from 1 wt % to 40 wt %, or from 1 wt % to 20 wt %, of the mogroside composition, based on the total dry weight of the mogroside composition. In some embodiments, mogroside V is the most abundant mogroside compound in the mogroside composition. For example, in some embodiments, mogroside V makes up from 50 wt % to 90 wt %, or from 60 wt % to 80 wt %, of the mogroside compounds, based on the total dry weight of mogroside compounds in the mogroside composition. In some embodiments, the mogroside composition comprises one or more natural sugars, such as sucrose, glucose, or fructose. Such sugars can be present in any suitable concentration. For example, in some embodiments, sugars selected from the group consisting of sucrose, glucose, fructose, and combinations thereof make up from 30 wt % to 95 wt %, or from 40 wt % to 95 wt %, or from 50 wt % to 95 wt %, of the mogroside composition, based on the total dry weight of the mogroside composition. In some embodiments, the mogroside composition is monk fruit juice, which can be in its unconcentrated, concentrated, or dried powder form. In some embodiments, the mogroside composition if monk fruit juice concentrate.

The mogroside composition is introduced to or used in combination with a fruit juice composition. Any suitable fruit juice compositions can be used. Note that such fruit juice compositions can refer to fruit juices (including vegetable juices) in either their unconcentrated or concentrated form. Non-limiting examples of fruit used for such fruit juices include acai, apple, avocado, beet, blackberry, blackcurrant, cantaloupe, carrot, celery, cherry, cranberry, coconut, cucumber, dandelion green, gooseberry, grape, grapefruit, guava, honeydew, kale, kiwi, lemon, lime, lingonberry, lychee, mango, melon, orange, papaya, parsley, passionfruit, peach, pineapple, pomegranate, pomelo, prune, raspberry, rhubarb, spinach, strawberry, sugarcane, tangerine, tomato, turnip, watercress, wheat grass, or any combinations thereof.

In some embodiments, the fruit juice composition comprises citrus fruit juice, such as the fruit juice of oranges, grapefruit, lemons, limes, pomelo, tangerines, or any combinations thereof. In some such embodiments, at least a portion of the citrus fruit juice is derived from fruit having citrus greening disease. In such cases, the citrus juice comprises elevated concentrations of limonin or nomelin. In some such embodiments, the mogroside composition is used to reduce a bitter taste of the fruit juice composition, for example, caused by fruit having citrus greening disease.

In some embodiments, the fruit juice composition comprises the juice of one or more fruits that are especially sour, such as grapefruit, rhubarb, cherries, gooseberries, cranberries, pineapple, or any combination thereof. In some such embodiments, the mogroside composition is used to reduce a sour taste of the fruit juice composition.

In some embodiments, the fruit juice composition comprises the juice of one or more fruits that are lower in sugar, such as apple or pear. In some such embodiments, the mogroside composition is used to enhance a sweet taste of the fruit juice composition.

In some embodiments, the fruit juice composition comprises the juice of one or more fruits that are high in astringent flavonoids, such as cranberries, blueberries, black currants, plums, cacao, or any combination thereof. In some such embodiments, the mogroside composition is used to reduce an astringent taste of the fruit juice composition.

In some embodiments, the fruit juice composition comprises cranberry juice. In some embodiments, the fruit juice composition comprises cranberry juice and one or more additional fruit juices selected from apple juice or pear juice. In some embodiments, the fruit juice composition comprises a citrus juice, such as orange juice, wherein at least a portion of the juice is derived from fruit having citrus greening disease.

In some embodiments, the fruit juice composition comprises a lower concentration of volatile flavor compounds, such as aroma compounds, in comparison to the fruit (for example, due to the loss of volatile flavor compounds during processing). In such cases, introducing the mogroside composition can enhance a fruity flavor of the juice composition.

The mogroside composition can be introduced or used in combination with the juice composition in any suitable concentration. In some embodiments, the total mogroside concentration in the modified juice composition ranges from 100 ppm to 1000 ppm, or from 150 ppm to 800 ppm, or from 200 ppm to 700 ppm. In some embodiments, the mogroside V concentration in the modified juice composition ranges from 50 ppm to 700 ppm, or from 100 ppm to 600 ppm, or from 150 ppm to 500 ppm.

In certain aspects, the disclosure provides the resulting modified juice composition resulting from the introduction of the mogroside composition. Thus, in certain aspects, the disclosure provides a modified juice composition, comprising: (a) a fruit juice composition; and (b) a mogroside composition. In its various embodiments, the concentrations of various components is consistent with those set forth in the preceding paragraphs.

### Additional Components

In some embodiments, the juice composition or the resulting sweetened juice composition can contain one or more additional components.

In some embodiments, the juice composition or sweetened juice composition includes other sweeteners or combinations of other sweeteners. In some embodiments, the other sweetener is a common saccharide sweetener, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the sweetener is a combination of two or more of the sweeteners set forth in this paragraph. In some embodiments, the sweetener may combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar may be sucrose. In some embodiments, the sugar may be a combination of fructose and glucose.

The other sweetener can also include, for example, sweetener comprises one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green Stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet Stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

Other sweeteners also include combinations of any two or more of any of the aforementioned sweeteners. In some embodiments, the sweetener may comprise combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a caloric sweetener, such as sucrose, fructose, xylitol, erythritol, or combinations thereof. In some embodiments, the ingestible compositions are free (or, in some embodiments) substantially free of Stevia-derived sweeteners, such as steviol glycosides, glucosylated steviol glycosides, or rebaudiosides.

In some embodiments, the juice composition or sweetened juice composition comprises a sour tastant, such as an organic acid. Non-limiting examples of such organic acids include acetic acid, malonic acid, malic acid, ascorbic acid, citric acid, lactic acid, and the like.

The juice composition or sweetened juice composition can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, Panax ginseng extract, guanana extract, ginger extract, L-phenylalanine, L-carnitine, L-tartrate, D-glucoronolactone, inositol, bioflavonoids, Echinacea, Gingko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulfate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

The juice composition or sweetened juice composition can have any suitable pH. In some embodiments, the mogroside composition reduces the perceived sourness of the juice composition over a broad range of pH, e.g., from lower pH to neutral pH. The lower and neutral pH includes, but is not limited to, a pH from 1.5 to 9.0, or from 2.5 to 8.5; from 3.0 to 8.0; from 3.5 to 7.5; and from 4.0 to 7. In certain embodiments, compounds as disclosed and described herein, individually or in combination, can enhance the perceived sweetness of a fixed concentration of a sweetener in taste tests at a compound concentration of 50 μM, 40 μM, 30 μM, 20 μM, or 10 μM at both low to neutral pH value. In certain embodiments, the enhancement factor of the compounds as disclosed and described herein, individually or in combination, at the lower pH is substantially similar to the enhancement factor of the compounds at neutral pH. Such consistent sweet enhancing property under a broad range of pH allow a broad use in a wide variety of foods and beverages of the compounds as disclosed and described herein, individually or in combination.

In some embodiments, the juice composition or sweetened juice composition comprises a flavoring. Any suitable flavoring can be used. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, Eucalyptus oil, thyme oil, cedar leaf oil, oil of nutmeg, allspice, oil of sage, mace, oil of bitter almonds, and Cassia oil. Non-limiting examples of other flavors include natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, Papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an Angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a Sassafras flavor, a savory flavor, a Zanthoxyli Fructus flavor, a Perilla flavor, a juniper berry flavor, a ginger flavor, a star anise flavor, a horseradish flavor, a thyme flavor, a tarragon flavor, a dill flavor, a Capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish creme, white chocolate, raspberry, pumpkin pie spice, peppermint, or any combination thereof.

*In some embodiments, the juice composition or sweetened juice composition comprises a sweetness enhancer. Any suitable sweetness enhancer can be used in the ingestible compositions disclosed herein, including synthetic sweetness enhancers, natural sweetness enhancers, or any combinations thereof.

Examples of suitable synthetic sweetness enhancers include, but are not limited to, N-(1-((4-amino-2,2-dioxo-1H-benzo[c][1,2,6]thiadiazin-5-yl)oxy)-2-methylpropan-2-yl)isonicotinamide, or any of its comestbly acceptable salts, 3-hydroxybenzoic acid, or any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032.

Suitable examples of natural sweetness enhancers include, but are not limited to, hesperetin dihydrochalcone, hesperetin dihydrochalcone-4‘-O’glucoside, neohesperetin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, thaumatin, monellin, miraculin, glycyrrhizin and comestible acceptable salts thereof (such as the mono-ammonium salt), naringin dihydrochalcone, myricetin, nobiletin, polymethoxyflavones, mixed methoxy- and hydroxyflavones, quercetin, certain amino acids, and the like. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth.

In some embodiments of any of the preceding embodiments, the juice composition or sweetened juice composition comprises 3-((4-amino-2,2-dioxo-1H-benzo[c][1,2,6]thiadiazin-5-yl)oxy)-2,2-dimethyl-N-propyl-propanamide, N-(1-((4-amino-2,2-dioxo-1H-benzo[c][1,2,6]-thiadiazin-5-yl)oxy)-2-methyl-propan-2-yl)isonicotinamide, or a comestibly acceptable salt thereof. In some embodiments, the ingestible composition comprises N-(1-((4-amino-2,2-dioxo-1H-benzo[c][1,2,6]thiadiazin-5-yl)oxy)-2-methyl-propan-2-yl)isonicotinamide, or a comestbly acceptable salt thereof. In some embodiments, the ingestible composition comprises N-(1-((4-amino-2,2-dioxo-1H-benzo[c][1,2,6]thiadiazin-5-yl)oxy)-2-methyl-propan-2-yl)isonicotinamide.

In some embodiments, the juice composition or sweetened juice composition comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl)decane-3,5-diol diacetate. In some embodiments, the umami-enhancing compound is N-(heptan-4-yl)benzo-[d][1,3]dioxole-5-carboxamide.

In some further embodiments, the juice composition or sweetened juice composition comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727. Non-limiting examples include N-ethyl-N-(thiophen-2-ylmethyl)-2-(p-tolyloxy)acetamide, N-(1H-pyrazol-3-yl)-N-(thiophen-2-ylmethyl)-2-(p-tolyloxy)acetamide, 2-(4-fluorophenoxy)-N-(1H-pyrazol-3-yl)-N-(thiophen-2-ylmethyl)acetamide, 2-(2-hydroxy-4-methylphenoxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiazol-5-ylmethyl)-acetamide, 2-((5-methoxybenzofuran-2-yl)oxy)-N-(1H-pyrazol-3-yl)-N-(thiophen-2-ylmethyl)-acetamide, (E/Z)-2-methyl-2-butenal, (E/Z)-2-isopropyl-5-methyl-2-hexenal, phloretin, naringenin, and any combinations thereof.

In some further embodiments, the juice composition or sweetened juice composition comprises one or more bitterness blocking or bitter masking compounds. Such bitterness blocking compounds or bitter masking include, but are not limited to, naturally derived compounds or synthetic compounds, such as any compounds set forth in U.S. Pat. Nos. 8,076,491; 8,445,692; and 9,247,759. Non-limiting examples include 3-(1-((3,5-dimethylisoxazol-4-yl)-methyl)-1H-pyrazol-4-yl)-1-(3-hydroxybenzyl)-imidazolidine-2,4-dione, 4-(2,2,3-trimethyl-cyclopentyl)butanoic acid, 3β-hydroxydihydrocostunolide, 3β-hydroxypelenolide, probenecid, sakuranetin, 6-methoxysakuranetin, jaceosidin, 4′-fluoro-6-methoxyflavonone, 6,3′-dimethoxyflavonone, 6-methoxyflavonone, γ-aminobutyric acid, Nα,Nα-bis(carbomethyl)-L-lysine, (+/−) abscisic acid, sodium gluconate, monosodium glutamate, sodium acetate, homoeriodictyol, sterubin, eriodictyol, 2,4,dihydrobenzoic acid, neodiosmin, 1-carboxymethyl-5-hydroxy-2-hydroxymethylpyridinium, flavan-3-spiro-C-glycosides, poly-γ-glutamic acid, α,α-trehalose, taurine, (2)-gingerdione, 2,4,-dihydroxybenzoic acid, L-theanine, enterodiol, lariciresinol, enterolactone, matairesinol, and any combinations thereof.

In some further embodiments, the juice composition or sweetened juice composition comprises one or more sour taste modulating compounds.

In some further embodiments, the juice composition or sweetened juice composition comprises one or more mouthfeel modifying compounds. Such mouthfeel modifying compounds include, but are not limited to, tannins, cellulosic materials, bamboo powder, and the like.

In some further embodiments, the juice composition or sweetened juice composition comprises one or more flavor masking compounds. Such flavor masking compounds include, but are not limited to, cellulosic materials, materials extracted from fungus, materials extracted from plants, citric acid, carbonic acid (or carbonates), and the like.

### Flavored Products

In certain aspects, the disclosure provides flavored products comprising any ingestible compositions of the preceding aspects. In some embodiments, the flavored products are beverage products, such as soda, flavored water, tea, and the like.

In embodiments where the flavored product is a beverage, the beverage may be selected from the group consisting of enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage may be a soft drink.

The Beverage category usually means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes the alcoholic drinks, the soft drinks, sports drinks, isotonic beverages, and hot drinks. The alcoholic drinks include, but are not limited to beer, cider/perry, FABs, wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described and claimed herein. The reader will recognize that the skilled artisan, armed with the present disclosure, and skill in the art is able to prepare and use the invention without exhaustive examples.

### Example 1—Monk Fruit Juice Sweetening of Cranberry-Apple-Pear Juice

Juice blends were prepared using cranberry juice concentrate, apple juice concentrate, pear juice concentrate, and monk fruit juice concentrate (Layn, Guilin, China). Table 1 shows the composition of a comparative example (without the monk fruit juice added) and a test example (with the monk fruit juice added).

TABLE 1

| | Comparative | Test |
|---|---|---|
| | Sample (g) | Sample (g) |
| Apple Juice Concentrate | 8.66 | 8.58 |
| Pear Juice Concentrate | 3.71 | 3.67 |
| Cranberry Juice Concentrate | 4.12 | 4.08 |
| Monk Fruit Juice Concentrate | — | 0.16 |
| Water | 83.51 | 83.51 |

A panel of sensory testers evaluated both the Comparative Sample and the Test Sample. The panelists were asked to evaluate the two samples for peak sweetness, mouthfeel, astringency, bitterness, and sourness. The results of the panelist scoring showed that the Test Sample: (a) had significantly better peak sweetness compared to the Comparative Sample; (b) had significantly better mouthfeel compared to the Comparative Sample; (c) had significantly reduced bitterness compared to the Comparative Sample; (d) had significantly reduced astringency compared to the Comparative Sample; and had directionally lower sourness compared to the Comparative Sample. Thus, by introducing a small amount of monk fruit juice to a juice blend containing low-sugar juices and an astringent juice, the monk fruit juice was able to provide significant flavor-related improvements.

1. Use of a mogroside composition to reduce one or more undesirable flavors of a fruit juice composition.

2. The use of claim 1, wherein the use comprises enhancing a sweet taste, reducing a bitter taste, reducing a sour taste, reducing an astringent taste, or enhancing mouthfeel.

3. The use of claim 1 or 2, wherein the mogroside composition is monk fruit juice or monk fruit juice concentrate.

4. The use of any one of claims 1 to 3, wherein the use comprises introducing the mogroside composition to the fruit juice composition such that the total mogroside content ranges from 100 ppm to 1000 ppm.

5. The use of any one of claims 1 to 4, wherein the mogroside composition comprises one or more natural sugars selected from the group consisting of sucrose, fructose, glucose, and combinations thereof.

6. The use of any one of claims 1 to 5, wherein the fruit juice composition is a citrus juice composition, wherein at least a portion of citrus juice composition is derived from fruit having citrus greening disease.

7. The use of claim 6, wherein the citrus juice composition is orange juice or orange juice concentrate.

8. The use of any one of claims 1 to 5, wherein the fruit juice composition comprises cranberry juice or cranberry juice concentrate.

9. The use of claim 8, wherein the fruit juice composition comprises a juice or concentrate of apple, pear, or a combination thereof.

10. A modified juice composition comprising: (a) a fruit juice composition; and (b) a mogroside composition.

11. The composition of claim 10, wherein the mogroside composition is monk fruit juice or monk fruit juice concentrate.

12. The composition of claim 10 or 11, wherein the composition comprises mogroside compounds at a concentration ranging from 100 ppm to 1000 ppm.

13. The composition of any one of claims 10 to 12, wherein the fruit juice composition is a citrus juice composition, wherein at least a portion of citrus juice composition is derived from fruit having citrus greening disease.

14. The composition of claim 13, wherein the citrus juice composition is orange juice or orange juice concentrate.

15. The composition of any one of claims 10 to 12, wherein the fruit juice composition comprises cranberry juice or cranberry juice concentrate.
